(19) United States
(12) Patent Application Publication
(10) Pub. No.: US 2012/0303352 A1
(43) Pub. Date: Nov. 29, 2012

(54) METHOD AND APPARATUS FOR ASSESSING A TRANSLATION

(75) Inventors: Gary A. Coen, Bellevue, WA (US); Ping Xue, Redmond, WA (US)

(73) Assignee: The Boeing Company

(21) Appl. No.: 13/114,551

(22) Filed: May 24, 2011

(51) Int. Cl. G06F 17/28

(52) U.S. Cl. 704/2

(57) ABSTRACT

Methods, apparatus and computer program products are provided in order to assess a translation following performance of the translation. The methods, apparatus and computer program products may determine input segments of a source language document that may prove to be problematic from a translatability standpoint, such as the input segments of the source language document that may have multiple output variants. As such, methods, apparatus and computer program products may provide feedback to the author or owner of the source language document that may influence the generation of subsequent source language documents so as to have improved translatability.

### TECHNOLOGICAL FIELD

Embodiments of the present disclosure relate generally to methods, apparatus and computer program products for assessing a translation and, more particularly, to methods, apparatus and computer program products for assessing a translation following performance of the translation so as to identify, for example, one or more segments of a source language document that may be problematic for translators.

### BACKGROUND

Global organizations, among many others, depend on document translations. Translation in industrial sectors such as utilities, manufacturing, and transportation require mastery of various technical disciplines, and translation errors or ambiguities can lead to financial and other adverse consequences. Some publication policies prescribe best practices for translating technical documentation into the languages of the receiving nations. These best practices usually permit authors or other document providers to exert control over the translation in a manner that balances cost with translation quality. However, this practice offers little control to an organization that produces line-of-business documents in only one language, especially when that organization's business model depends on foreign customers to translate received documents independently. According to this practice, source language documents are translated into target language documents by parties other than the owner of the source language document even though the owner of the source language document retains a proprietary interest in the quality of the translation notwithstanding the limited knowledge by the owner of the source language document of the target language.

In the absence of control over the translation itself, it could be beneficial for the owner of a source language document to draft the document so as to be more readily translatable. Translatability of a document denotes those properties of a source language document that increase the potential for successful translation of the source language document. Translation quality also depends on translatability and several different techniques have been developed for assessing translation quality, typically in the context of the prediction of translation costs in advance of the actual translation. For example, round-trip translation may be applied casually to machine-translation (MT) systems. In round-trip translation, source language (SL) input is translated into target language (TL) output by an MT system. This output is then re-translated from the TL back into the initial SL, and the final translation product is then compared to the original input to assess the translation quality of the MT system. Human judgment may determine when round-trip translation inputs and outputs are semantically equivalent or divergent. Although once thought to be an indicator of translation quality, especially when evaluators lack TL knowledge, round-trip translation quality assessment is now considered less helpful since round-trip translation fails to differentiate the distinct SL-TL and TL-SL contributions to the final translation product.

Regarding the relationship between translatability and translation quality, the relationship or correlation is suggested by the dependency between translatability assessment and post-editing costs. In this regard, translatability assessment may be used to predict translation costs. Typically, when translatability scores match translation capabilities, pre- and post-editing cost estimates are minimal. Otherwise, more time and effort are deemed necessary for an acceptable translation product. In either case, translation quality is predicted as a function of SL translatability and translation cost. Understanding of this relationship is useful when deciding how to effect a translation and which technologies to apply when human translation is prohibitively expensive or otherwise infeasible.

Some study has been undertaken to understand the formal parameters of translatability, that is, those properties of SL input that increase the potential for successful translation. In this regard, it has been suggested that authoring or pre-processing SL input with a controlled language (CL) enhances translatability. In this regard, translatability assessment typically identifies SL properties that act as impediments to translation. Usually these properties are aspects of SL non-compliance with CL specifications. Typically, non-compliance implicates lexical and grammatical restrictions that neutralize marked features of the SL from which the CL is adapted. In this way, the approach first assesses SL inputs with respect to an idealized, unmarked CL, which figures as a proxy for the actual TL. These studies eventually led to translatability assessment independent of the TL involved. Other studies employ machine learning to assess the translatability of SL inputs and reformulate them as necessary to enhance translatability. In general, the objective of these forms of translatability assessment is to predict the time and cost required for translation.

As such, translatability assessment techniques have been generally utilized prior to translation so as to determine, for example, the manner in which to execute a translation task. As such, the translatability assessment techniques described above may facilitate a determination as to how to effect a translation and which technologies to apply in an instance in which human translation is prohibitively expensive or otherwise unfeasible. However, translatability assessment techniques have not been widely utilized for purposes other than for pre-translation guidance in order to, for example, predict translation costs.

### BRIEF SUMMARY

Methods, apparatus and computer program products are provided in accordance with embodiments of the present disclosure in order to assess a translation following performance of the translation. The methods, apparatus and computer program products of one embodiment may determine input segments of a source language document that may prove to be problematic from a translatability standpoint. As such, methods, apparatus and computer program products of the present disclosure may provide feedback to the author or owner of the source language document that may influence the generation of subsequent source language documents so as to have improved translatability.

In one embodiment, a method of assessing a translation is provided that includes aligning, with a processor, input segments of a source language document with corresponding output segments of a target language document. For each input segment, the method identifies variations between the output segments corresponding to a respective input segment. In this regard, the identification of the variations includes the identification of a reference translation and one or more output variants for the respective input segment. For example, the reference translation may be the output segment that most frequently corresponds to the respective input segment. The method of this embodiment also determines the one or more input segments having corresponding output variants that fail to satisfy a control limit for translation variation.

The method of one embodiment may also provide feedback regarding the one or more input segments having corresponding output variants that fail to satisfy a control limit for translation variation. As such, the recipient of the feedback, such as the author or owner of the source language document, can take the feedback into account during the production of other source language documents to improve the translatability of those other source language documents. In one embodiment, the determination of the one or more input segments having corresponding output variants that fail to satisfy the control limit for translation variation may include the determination of a measurement of similarity between each output variant and the reference translation. The measurement of similarity may, in turn, be determined by determining a longest common subsequence between each output variant and the reference translation. Further, the measurement of similarity may be determined by determining a similarity metric based upon recall and precision of the longest common subsequence between each output variant and the reference translation. In one embodiment, the control limit is based upon the similarity metric.

In one embodiment, a computing device for assessing a translation is provided that includes a processor configured to align input segments of a source language document with corresponding output segments of a target language document. For each input segment, the processor is configured to identify variations between the output segments corresponding to a respective input segment. In this regard, the identification of the variations includes the identification of a reference translation and one or more output variants for the respective input segment. For example, the reference translation may be the output segment that most frequently corresponds to the respective input segment. The processor of this embodiment is also configured to determine the one or more input segments having corresponding output variants that fail to satisfy a control limit for translation variation.

The processor of one embodiment may also be configured to provide feedback regarding the one or more input segments having corresponding output variants that fail to satisfy a control limit for translation variation. As such, the recipient of the feedback, such as the author or owner of the source language document, can take the feedback into account during the production of other source language documents to improve the translatability of those other source language documents. In one embodiment, the determination of the one or more input segments having corresponding output variants that fail to satisfy the control limit for translation variation may include the processor's determination of a measurement of similarity between each output variant and the reference translation. The measurement of similarity may, in turn, be determined by the processor determining a longest common subsequence between each output variant and the reference translation. Further, the measurement of similarity may be determined by the processor's determining a similarity metric based upon recall and precision of the longest common subsequence between each output variant and the reference translation. In one embodiment, the control limit is based upon the similarity metric.

In one embodiment, a computer program product for assessing a translation is provided that includes at least one computer-readable storage medium having computer-executable program code portions stored therein. The computer-executable program code portions include program code instructions for aligning input segments of a source language document with corresponding output segments of a target language document. For each input segment, the computer-executable program code portions include program code instructions for identifying variations between the output segments corresponding to a respective input segment. In this regard, the identification of the variations includes the identification of a reference translation and one or more output variants for the respective input segment. For example, the reference translation may be the output segment that most frequently corresponds to the respective input segment. The computer-executable program code portions of this embodiment also include program code instructions for determining the one or more input segments having corresponding output variants that fail to satisfy a control limit for translation variation.

The computer-executable program code portions of one embodiment also include program code instructions for providing feedback regarding the one or more input segments having corresponding output variants that fail to satisfy a control limit for translation variation. As such, the recipient of the feedback, such as the author or owner of the source language document, can take the feedback into account during the production of other source language documents to improve the translatability of those other source language documents. In one embodiment, the program code instructions for determining the one or more input segments having corresponding output variants that fail to satisfy the control limit for translation variation may include program code instructions for determining a measurement of similarity between each output variant and the reference translation. The measurement of similarity may, in turn, be determined by program code instructions for determining a longest common subsequence between each output variant and the reference translation. Further, the measurement of similarity may be determined by program code instructions for determining a similarity metric based upon recall and precision of the longest common subsequence between each output variant and the reference translation. In one embodiment, the control limit is based upon the similarity metric.

In accordance with embodiments of the present disclosure, a method, apparatus and computer program product are provided in order to assess a translation and to identify input segments of a source language document that may be problematic from a translatability standpoint. As such, authors, owners or other providers of source language documents may take into account the input segments that have poor translatability in order to subsequently produce other source language documents that are more readily translatable. However, the features, functions and advantages that have been discussed may be achieved independently and the various embodiments of the present disclosure may be combined in the other embodiments, further details of which may be seen with reference to the detailed description and drawings.

### BRIEF DESCRIPTION OF THE DRAWINGS

Having thus described embodiments of the present disclosure in general terms, reference will now be made to the accompanying drawings, which are not necessarily drawn to scale, and wherein:

FIG. 1 is a flow chart illustrating operations performed in accordance with one embodiment of the present disclosure;

FIG. 2 is a flow chart illustrating operations performed in accordance with another embodiment of the present disclosure; and

FIG. 3 is a block diagram illustrating a computing device for performing operations in accordance with one embodiment of the present disclosure.

### DETAILED DESCRIPTION

Embodiments of the present disclosure now will be described more fully hereinafter with reference to the accompanying drawings, in which some, but not all embodiments are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout.

A method, apparatus and computer program product are provided according to one embodiment of the present disclosure for assessing a translation of a source language document following the generation or production of the translation. Based upon the assessment of the translation, feedback may be provided to the author or owner of the source language document to indicate input segments of the source language document that are problematic from a translatability standpoint, such as those input segments that lend themselves to a plurality of different translations. Based upon this feedback, the source language document may be revised or other source language documents may be subsequently created that take into account the results of the translatability assessment so as to create source language documents that are more consistently and accurately translated.

While the methods, apparatus and computer program products of embodiments of the present disclosure may be utilized in a variety of situations, the methods, apparatus and computer program products of one embodiment are useful in an instance in which the author or owner of the source language document does not perform or otherwise have control over the translation of the source language document. For example, the author or owner of the source language document may create and provide a monolingual document to another party, such as a customer, a partner or the like. The other party may then translate the source language document independent of any input or control by the author or owner of the source language document. As a result of its authorship or ownership of the source language document, however, the author or owner of the source language document still has an interest in the quality of the translation to ensure that the content of the source language document is accurately and consistently reproduced in the target language. By acting upon feedback provided in accordance with embodiments of the present disclosure, the author or owner of a source language document may work to improve the translatability of subsequent source language documents, thereby reducing the risks associated with poor translations of the source language documents.

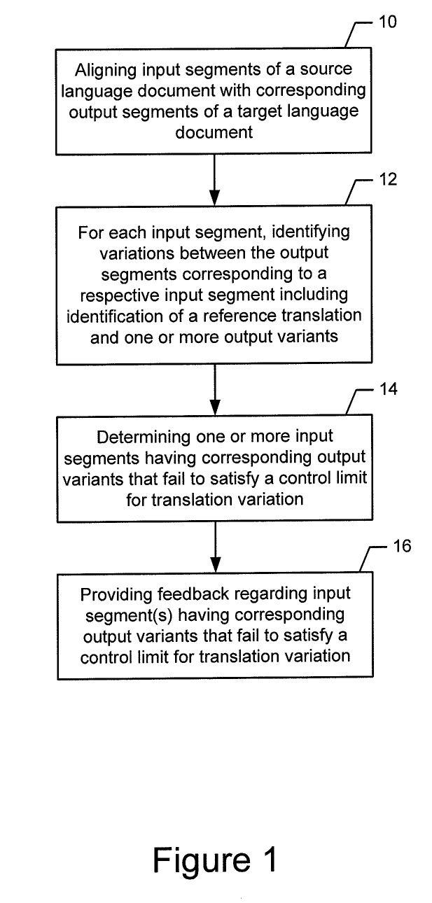

The methods, apparatus and computer program products of embodiments of the present disclosure generally identify input elements of the source language document that have poor translatability based upon the analysis of textual properties of a parallel pair of source language and target language documents. As shown in operation 10 of FIG. 1, a method of assessing a translation may initially align input segments of a source language document with corresponding output segments of a target language document. In this regard, the target language document is a translation of the source language document. The input and output segments that are aligned may be of various lengths. For example, the input and output segments may be sentences, phrases or other combinations of words and associated characters.

In the alignment process, an input segment of the source language document is aligned or matched with an output segment of the target language document that represents the same sentence, phrase or the like as does the input segment. Various alignment techniques may be utilized, such as that described at http://champollion.sourceforge.net. For example, an alignment technique may accept a parallel document pair, such as a source language document and a corresponding target language document, as an input and produce a bisegmentation relation that identifies mutual translation correspondences between segments of each document, such as between an input segment of the source language document and a corresponding output segment of the target language document. As noted, the granularity of the bisegmentation relations may vary from words, collocations, phrases, sentences, or other textual units. In one embodiment, for example, an alignment technique may utilize a length-based probabilistic algorithm supplemented with a domain-specific source language-target language lexical resource to produce sentence alignments. See, for example, Peng Li, et al., “Fast-Champollion: A Fast and Robust Sentence Alignment Algorithm”, Proceedings of the 23^{rd} International Conference on Computational Linguistics (COLING 2010).

For each input segment, the method may identify variations between the output segments that correspond to the respective input segment as shown in block 12 of FIG. 1. By way of illustration and without limitation or intent for aircraft or functional use, several input segments of an English language source document (designated “SL input”) are reproduced below in Table 1 along with the corresponding output segments of a Mandarin language target document (designated “TL output”) and the frequency (Freq) of occurrence of each output segment.

TABLE 1

| SL input | TL output | Freq |
|---|---|---|
| Pitch attitude to | [symbol] | 5 |
| remain outside the | | |
| red RA regions | | |
| | [symbol] | 1 |
| Present ADI pitch | [symbol] | 9 |
| attitude is within the | | |
| red RA regions | | |
| Traffic aircraft is | [symbol] [symbol] | 8 |
| either climbing or | | |
| descending in excess | | |
| | [symbol] [symbol] | 3 |
| Traffic aircraft | [symbol] [symbol] | 6 |
| is providing | | |
| altitude information | | |
| | [symbol] [symbol] | 4 |
| | [symbol] [symbol] | 3 |

One of the input segments of the source language document, that is, “Present ADI pitch attitude is within the red RA regions” has only a single corresponding output segment and therefore has no translation variations and, as a result, superior translatability. However, the other three input segments of the English language source document have two or more corresponding output segments in the Mandarin language target document. As such, these input segments that have multiple corresponding output segments have poorer translatability. Generally, however, some variation in the output segments of a target language document may be tolerable, while more substantial translation variations may be considered intolerable and indicative of poor translatability of the corresponding input segments of the source language document.

The relationship between input segments of a source language document and the corresponding output segments of a target language document that is reflected in Table 1 need not be presented to a user, but the underlying information regarding the corresponding output segments of the target language document and the frequency with which each of the corresponding output segments appears within the target language document may be utilized when assessing the translatability of the source language document. In order to assess the translation variations, the output segments of a target language document are reviewed to identify instances in which different output segments correlate to the same input segment. In this regard, those input segments of the source language document that have a single corresponding output segment are identified by the method to have no output variants. However, for each input segment of the source language document that has two or more corresponding output segments in the target language document, the method identifies a reference translation and one or more output variants. See operation 12 of FIG. 1. In this regard, the reference translation is generally the output segment corresponding to a respective input segment that occurs most frequently, while the other output segments corresponding to the same respective input segment are considered output variants. With respect to the example of Table 1, the “Pitch attitude to remain outside the red RA regions” input segment has a corresponding output segment ( [symbol] [symbol] ) that occurs most frequently, i.e., five times, and is identified as the reference translation, while the other corresponding output segment ( [symbol] [symbol] ) occurs less frequently, i.e., one time, and is identified as an output variant. As another example, the “Traffic aircraft is providing altitude information” input segment has a corresponding output segment ( [symbol] [symbol] ) that occurs most frequently, i.e., six times, and is identified as the reference translation, while the two other corresponding output segments occur less frequently, i.e., four and three times, and are identified as output variants.

Thereafter, the method may determine the one or more input segments of the source language document that have corresponding output variants that fail to satisfy a control limit for translation variation, as shown in block 14 of FIG. 1. By judicious selection of the control limit, the amount of translation variation that is tolerable may be adjusted depending upon the circumstances surrounding the translation of the source language document to the target language document. The determination of the input segment(s) that have corresponding output variants that fail to satisfy a control limit for translation variation may be accomplished in various manners. In one embodiment, however, the method may determine the input segment(s) having corresponding output variants that fail to satisfy the control limit for translation variation by determining a measurement of similarity between each output variant and the reference translation. In this regard, the determination of the measurement of similarity may include a determination of the longest common subsequence between each output variant and the reference translation.

In this regard, each output segment that corresponds to a respective input segment may be construed as a string of words and the similarity between the output segments varies directly based upon the length of the subsequence commonality between the strings of words. In this embodiment, output segments that have longer subsequence commonality will be considered more similar than output variants that have shorter subsequence commonality. For example, a common subsequence of reference translation X is any output variant Y that exhibits the word sequence of X with zero or more elements omitted. Expressed in terms of abstract sequences X, Y and Z, Z is regarded as a common subsequence of X and Y if Z is a subsequence of X and Y. For example, if X equals {A, B, C, B, D, A} and Y equals {B, D, C, A, B}, the sequence {B, C, A} is the common subsequence of X and Y. See, for example, Thomas H. Cormen, et al., “Introduction to Algorithms,” Third Edition, MIT Press (2009). By way of example and without limitation or intent for aircraft or functional use, Table 2 represents the output segments (TL output) of a Mandarin language target document that correspond to an input segment of “Traffic aircraft is providing altitude information” from an English language source document.

TABLE 2

| TL output | | Tokenized TL output |
|---|---|---|
| (1) | [symbol] [symbol] | [symbol] [symbol] |
| (2) | [symbol] [symbol] | [symbol] [symbol] |
| (3) | [symbol] [symbol] | [symbol] [symbol] [symbol] |

As shown, the output segments may be tokenized in order to break the output segments into a plurality of words or other lexical units. By way of example, the first output segment may serve as the reference translation with the second and third output segments being output variants of the reference translation. While the second and third output segments share a common subsequence with the first output segment for the words in sequential positions 0 and 1, the method may determine the longest common subsequence (LCS) for each output variant relative to the reference translation. In this regard, the longest common subsequence for the second output variant relative to the reference translation is the words in sequential positions 0, 1, 3 and 4. Similarly, the longest common subsequence for the third output variant relative to the reference translation involves the words in sequential positions 0, 1, 4 and 5. In general, for any two output segments X and Y with X being the reference translation, the longest common subsequence of X and Y denoted LCS (X, Y) is the maximum count of words that Y shares in common with X and which occur in Y in the same sequential order, but not necessarily consecutively, as they appear in X.

In one embodiment, the determination of the measurement of similarity may include the determination of a similarity metric based upon the recall and precision, such as the weighted harmonic mean of the recall and precision, of the longest common subsequence (LCS) between each output variant and the reference translation. In this embodiment, the control limit may, in turn, be based upon the similarity metric. As described by Chin-Yew Lin, et al., “Automatic Evaluation of Machine Translation Quality Using Longest Common Subsequence and Skip-Bigram Statistics”, Proceedings of the 42^{nd} Annual Meeting of the Association for Computational Linguistics (ACL 2004), for a reference translation X of length m and an output variant Y of length n, the weighted harmonic mean of the recall R_{lcs} for the LCS may be defined as:

$${R}_{lcs} ( X , Y ) = \frac{LCS ( X , Y )}{m} .$$

Additionally, the weighted harmonic mean of the precision P_{lcs} for the LCS may be defined as:

$${P}_{lcs} ( X , Y ) = \frac{LCS ( X , Y )}{n} .$$

Additionally, a weighting value β may be defined as:

$$β = \frac{{P}_{lcs} ( X , Y )}{{R}_{lcs} ( X , Y )} .$$

Although a similarity metric may be determined based upon the recall and precision of the longest common subsequence in various manners, the method of one embodiment may determine a similarity metric F_{lcs} (X, Y) as follows:

$${F}_{lcs} ( X , Y ) = \frac{( 1 + {β}^{2} ) {R}_{lcs} ( X , Y ) {P}_{lcs} ( X , Y )}{( {R}_{lcs} ( X , Y ) + {β}^{2} ) {P}_{lcs} ( X , Y )} .$$

By way of example and with reference to the reference translation, i.e., TL output (1), and the output variants, i.e., TL outputs (2) and (3), of Table 2, the similarity metric F_{lcs} (X, Y) is 0.8 for TL output (2) relative to the reference translation and 0.73 for TL output (3) relative to the reference translation in an instance in which the weighting value β equals one. Thus, the similarity metric of this embodiment takes into consideration word count variations between the output variants and the reference translation and confirms human intuition that, from among the output variants with the same LCS, the output variant having the same number of words as the reference translation has less variance from the reference translation than does an output variant that has a different number of words than the reference translation. As such, the longest common in-sequence n-gram information factored into the foregoing equation for the similarity metric F_{lcs} (X, Y) provides a target language output comparison metric having sensitivity for the empirical facts of linear precedence.

As noted above, the method may then utilize the similarity metric in order to define the control limit that establishes whether a translation variation is tolerable or intolerable. In one embodiment, the similarity measures for the plurality of output segments are presumed to be a normally-distributed random variable that are aggregated so as to determine a control limit for translation variation between a source language document and the target language document. Thus, output segments of the target language document that satisfy the control limit may be considered to be tolerable or acceptable even if those output segments vary somewhat from the reference translation, while output segments that fail to satisfy the control limit may be considered intolerable as a result of their excessive variation relative to the reference translation.

While the control limit may be based upon the similarity metric in a variety of different manners, one example of the relationship between the similarity metric and the control limit is provided herein for purposes of example, but not of limitation. In this example, vᵢ is an output variant that occurs in a parallel document pair, that is, a pair consisting of a source language document and a corresponding target language document, with a total of m output variants, excluding those output segments that serve as reference translations. Additionally, xᵢ is the LCS-based similarity measure obtained from F_{lcs}(vᵢ, rᵢ) in an instance in which rᵢ is the reference translation for vᵢ. In this example, the method may determine the arithmetic mean of the sum of all the differences between the similarity estimates for each xᵢ and its predecessor xᵢ₋₁ according to the following equation:

$$MR = \frac{{\sum }_{i = 2}^{m} \vert {x}_{i} - {x}_{i - 1} \vert}{m - 1} .$$

In this regard, the foregoing equation determines the moving range (MR) of translation variation across the parallel document pair. This moving range value quantifies the average translation variation. The control limit for translation variation may, in turn, be based upon the moving range MR and, in one embodiment, the control limit may be determined as the product of the moving range MR and the multiplier 2.66. In this regard, the multiplier 2.66 may be obtained by dividing 3 by the anti-biasing constant for n=2 as described, for example, in Douglas Montgomery, “Introduction to Statistical Quality Control”, John Wiley & Sons (2005).

Once a control limit has been established for translation variation, such as 2.66 MR, the method of one embodiment may compare the similarity measure xᵢ for each output variant vᵢ with the control limit in order to determine the output variants, if any, that exceed the control limit and which will, therefore, be considered to exceed the tolerable levels of translation variation established by the control limit. In an instance in which one or more input segments of a source language document have output segment(s) that exhibit an intolerable translation variation, the method may provide feedback to the author or owner of the source language document as shown in operation 16 of FIG. 1 such that the author or owner of the source language document may consider the input segment(s) that give rise to the intolerable translation variation and consider ways in which the input segment(s) could be rephrased or restructured in order to improve its translatability, either in another version of the same source language document or in other source language documents in the future. Based upon the feedback provided in accordance with the method of one example embodiment, translation irregularities may be anticipated such that source language documents may be subsequently optimized for translatability. As such, the method may provide for increased cross-cultural equivalence between source language documents and target language documents.

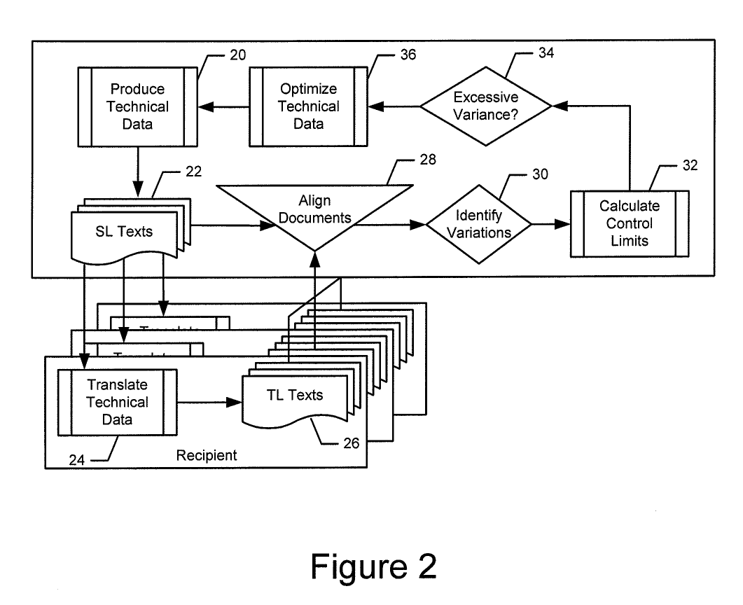

By way of a further example, FIG. 2 illustrates another representation of a method in which source language documents are produced, such as source language documents that include technical data. See operations 20 and 22 of FIG. 2. The source language documents of this embodiment may be provided to a recipient, such as another party different than the party that produced the source language document. The recipient may translate the source language documents, including the underlying technical data, into a plurality of corresponding target language documents. See operations 24 and 26 of FIG. 2. In accordance with an embodiment of the present disclosure, the target language documents may be provided to the original producer of the source language document and aligned with the corresponding source language documents. See operation 28 of FIG. 2. In this regard, input segments of a source language document may, in turn, be aligned with corresponding output segments of the target language document. For each input segment, variations between the output segments corresponding to the respective input segment may be identified and the frequency with which those output variations appear may be determined. See operation 30 of FIG. 2. Based upon the identification of the variations between the output segments corresponding to a respective input segment, a reference translation and one or more output variants may be determined for each input segment that has multiple corresponding output segments.

As described above, a control limit for translation variation may then be determined and the output variants may be compared to the control limit to determine if the output variants vary excessively. See operations 32 and 34 of FIG. 2. In instances in which an input segment of a source language document is determined to have one or more output variants that have an excessive variation, such as by failing to satisfy the control limit, the method may provide feedback such that the producer of the source language document, such as the author, the owner or the like of the source language document, may consider those input segments that have poor translatability and may consider revisions to the input segments of the source language document or similar input segments of other source language documents in an effort to improve the translatability of those input segments and the corresponding translatability of the source language document. As shown in operation 36 of FIG. 2, the potential revisions to an input segment of a source language document may include a revision or optimization of the technical data embodied within the source language document.

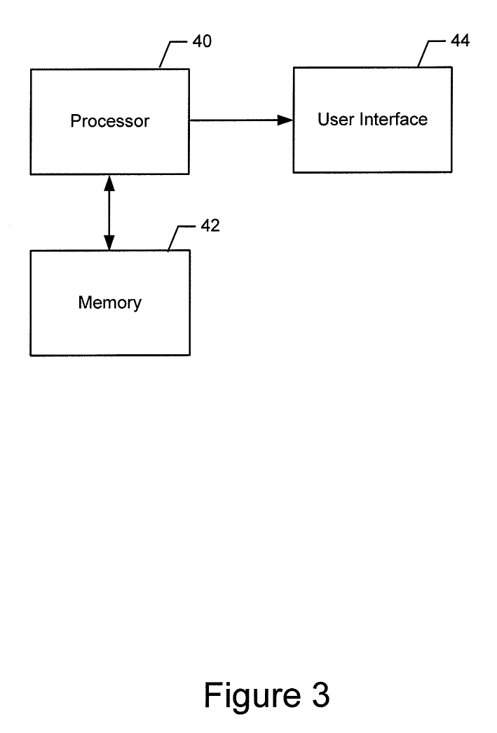

The methods described above and illustrated, for example, in FIGS. 1 and 2 may be implemented in an automated fashion, that is, without manual intervention, by a computing device, such as shown in FIG. 3. In this regard, the computing device of one embodiment of the present disclosure may include specifically configured processing circuitry such as a specifically configured processor 40, and an associated memory device 42, both of which are commonly comprised by a computer or the like. In this regard, the method of embodiments of the present invention as set forth generally in FIGS. 1 and 2 can be performed by the processor executing a computer program instructions stored by the memory device. The computing device can also include a user interface 44 including, for example, a display for presenting information and/or for receiving information relative to performing embodiments of the method of the present invention.

As noted above, the processor 40 may operate under control of a computer program product. In this regard, the computer program product for performing the methods of embodiments of the present disclosure includes a computer-readable storage medium, such as a non-volatile, non-transitory storage medium, and computer-readable program code portions, such as a series of computer instructions, embodied in the computer-readable storage medium.

In this regard, FIGS. 1 and 2 are flowcharts of methods, systems and program products according to embodiments of the present disclosure. It will be understood that each block or step of the flowchart, and combinations of blocks in the flowchart, can be implemented by computer program instructions. These computer program instructions may be loaded onto a computing device, such as shown in FIG. 3, or other programmable apparatus to produce a machine, such that the instructions which execute on the computing device or other programmable apparatus create means for implementing the functions specified in the flowchart block(s) or step(s). These computer program instructions may also be stored in a computer-readable memory, e.g., memory device 42, that can direct a computing device or other programmable apparatus to function in a particular manner, such that the instructions stored in the computer-readable memory produce an article of manufacture including instructions which implement the function specified in the flowchart block(s) or step(s). The computer program instructions may also be loaded onto a computing device or other programmable apparatus to cause a series of operational steps to be performed on the computing device or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of assessing a translation comprising:
aligning, with a processor, input segments of a source language document with corresponding output segments of a target language document;
for each input segment, identifying variations between the output segments corresponding to a respective input segment, wherein identifying the variations comprises identifying a reference translation and one or more output variants for the respective input segment; and
determining the one or more input segments having corresponding output variants that fail to satisfy a control limit for translation variation.

2. A method according to claim 1 further comprising providing feedback regarding the one or more input segments having corresponding output variants that fail to satisfy a control limit for translation variation.

3. A method according to claim 1 wherein identifying the reference translation comprises identifying the output segment that most frequently corresponds to the respective input segment.

4. A method according to claim 1 wherein determining the one or more input segments having corresponding output variants that fail to satisfy the control limit for translation variation comprises determining a measurement of similarity between each output variant and the reference translation.

5. A method according to claim 4 wherein determining the measurement of similarity comprises determining a longest common subsequence between each output variant and the reference translation.

6. A method according to claim 5 wherein determining the measurement of similarity comprises determining a similarity metric based upon recall and precision of the longest common subsequence between each output variant and the reference translation.

7. A method according to claim 6 wherein the control limit is based upon the similarity metric.

8. A computing device configured to assess a translation, wherein the computing device comprises a processor configured to align input segments of a source language document with corresponding output segments of a target language document, wherein the processor is also configured, for each input segment, to identify variations between the output segments corresponding to a respective input segment including identification of a reference translation and one or more output variants for the respective input segment, and wherein the processor is configured to determine the one or more input segments having corresponding output variants that fail to satisfy a control limit for translation variation.

9. A computing device according to claim 8 wherein the processor is further configured to provide feedback regarding the one or more input segments having corresponding output variants that fail to satisfy a control limit for translation variation.

10. A computing device according to claim 8 wherein the processor is configured to identify the reference translation by identifying the output segment that most frequently corresponds to the respective input segment.

11. A computing device according to claim 8 wherein the processor is configured to determine the one or more input segments having corresponding output variants that fail to satisfy the control limit for translation variation by determining a measurement of similarity between each output variant and the reference translation.

12. A computing device according to claim 11 wherein the processor is configured to determine the measurement of similarity by determining a longest common subsequence between each output variant and the reference translation.

13. A computing device according to claim 12 wherein the processor is configured to determine the measurement of similarity by determining a similarity metric based upon recall and precision of the longest common subsequence between each output variant and the reference translation.

14. A computing device according to claim 13 wherein the control limit is based upon the similarity metric.

15. A computer program product for assessing a translation and comprising at least one computer-readable storage medium having computer-executable program code portions stored therein, the computer-executable program code portions comprising:
program code instructions for aligning input segments of a source language document with corresponding output segments of a target language document;
for each input segment, program code instructions for identifying variations between the output segments corresponding to a respective input segment, wherein identifying the variations comprises identifying a reference translation and one or more output variants for the respective input segment; and
program code instructions for determining the one or more input segments having corresponding output variants that fail to satisfy a control limit for translation variation.

16. A computer program product according to claim 15 further comprising program code instructions for roviding feedback regarding the one or more input segments having corresponding output variants that fail to satisfy a control limit for translation variation.

17. A computer program product according to claim 15 wherein the program code instructions for identifying the reference translation comprise program code instructions for identifying the output segment that most frequently corresponds to the respective input segment.

18. A computer program product according to claim 15 wherein the program code instructions for determining the one or more input segments having corresponding output variants that fail to satisfy the control limit for translation variation comprise program code instructions for determining a measurement of similarity between each output variant and the reference translation.

19. A computer program product according to claim 18 wherein the program code instructions for determining the measurement of similarity comprise program code instructions for determining a longest common subsequence between each output variant and the reference translation.

20. A computer program product according to claim 5 wherein the program code instructions for determining the measurement of similarity comprise program code instructions for determining a similarity metric based upon recall and precision of the longest common subsequence between each output variant and the reference translation, wherein the control limit is based upon the similarity metric.
